(19) United States
(12) Patent Application Publication
(10) Pub. No.: US 2019/0295487 A1
(43) Pub. Date: Sep. 26, 2019

(54) LARGE-SIZE LIQUID CRYSTAL DISPLAY

(71) Applicant: Shenzhen China Star Optoelectronics Semiconductor Display Technology Co., Ltd., Shenzhen (CN)

(72) Inventor: Sikun HAO, Shenzhen (CN)

(21) Appl. No.: 16/112,389

(22) Filed: Aug. 24, 2018

Related U.S. Application Data
(63) Continuation of application No. PCT/CN2018/092355, filed on Jun. 22, 2018.

(30) Foreign Application Priority Data
Mar. 20, 2018 (CN) 201810231633.1

(51) Int. Cl. G09G 3/36

(52) U.S. Cl. CPC G09G 3/3666; G09G 3/3607; G09G 2310/0278; G09G 2320/0233; G09G 2310/0221

(57) ABSTRACT

A large-size liquid crystal display is disclosed. The display includes multiple sub-pixels arranged as a matrix, multiple rows of scanning lines, and multiple columns of data lines which are vertically intersected to form multiple pixel regions; the multiple sub-pixels arranged as a matrix are respectively located in the multiple pixel regions; wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed. The present invention can eliminate a poor display.

### CROSS-REFERENCE TO RELATED APPLICATION

This application is a continuing application of PCT Patent Application No. PCT/CN2018/092355, entitled “LARGE-SIZE LIQUID CRYSTAL DISPLAY”, filed on Jun. 22, 2018, which claims priority to China Patent Application No. CN201810231633.1 filed on Mar. 20, 2018, both of which are hereby incorporated in its entireties by reference.

### FIELD OF THE INVENTION

The present invention relates to the display technology field, and more particularly to a large-size liquid crystal display.

### BACKGROUND OF THE INVENTION

The liquid crystal display is currently the most widely used flat panel display, and has gradually become a high resolution color screen is widely used in a variety of electronic devices such as mobile phones, personal digital assistants (PDAs, personal digital assistants, also known as handheld computers), digital cameras, computer screens or laptop screen.

At present, a liquid crystal display generally used is generally formed by an upper and lower substrates and an intermediate liquid crystal layer, and the substrate is formed by a glass substrate and an electrode. If the upper and lower substrates have electrodes, a vertical electric field mode display such as a TN (Twist Nematic) mode, a VA (Vertical Alignment) mode, and a MVA (Multi-domain Vertical Alignment) mode used for solving a narrow viewing angle can be formed. The other type is different from the above display, the electrode is only located on one side of the substrate, and the display forms a transverse electric field mode, such as an IPS (In-plane switching) mode, an FFS (Fringe Field Switching) mode, and the like.

The liquid crystal display in public locations requires large screens. Currently, a single-panel screen display devices with 100-inch or larger screens are not popular, so that a large-size and single-panel screen display device is limited by panel resolution, resistance, and capacitance such that an original image is necessary to divide into multiple display regions and perform independent display driving.

For example, as shown in FIG. 1, the display regions of a large-size liquid crystal display can be divided into four display regions 11, 12, 13, and 14. These four regions are separately driven and displayed, and ae corresponding driving circuit of the large-size liquid crystal display is as shown in FIG. 2, which includes multiple rows of scanning lines (G-5 to G5) and multiple columns of data lines (D-5 to D5), each scanning line includes two scan line segments, and the two scan line segments are respectively located on two sides of a sixth column of data line D0 (for example, the two scanning line segments G51 and G52 of the first row of scanning line G5 are located on two sides of the sixth column of data line D0). Each column of data line includes two data line segments, which are respectively located on a sixth row of scanning line G0 (for example, the two data line segments D51 and D52 of an eleventh column of data line D5 are respectively located in two sides of a sixth row of scanning line G0).

The sixth column of data line D0 is a boundary line between the display region 11, 13 and the display regions 12, 14, and the sixth row of scanning line G0 is a boundary line of the display regions 11, 12 and the display regions 13, 14.

As shown in FIG. 3, the breakpoints on each scanning line are located on the data line D0; as shown in FIG. 4, the breakpoints on each data lines are located on the scanning line G0.

The difference in driving between the left and right scanning lines causes poor display of the liquid crystal display in the vertical direction and the driving difference between the upper and lower data lines, resulting in poor display of the liquid crystal display in the horizontal direction. Therefore, such a driving circuit structure will generate a “+” shape display defect in the middle of the liquid crystal display screen.

### SUMMARY OF THE INVENTION

In order to solve the above technical problems, the present invention provides a large-size liquid crystal display capable of eliminating the poor display defects in the middle of a large-sized liquid crystal display screen.

The present invention provides a large-size liquid crystal display, comprising: multiple sub-pixels arranged as a matrix, multiple rows of scanning lines, and multiple columns of data lines; the multiple rows of scan lines and the multiple columns of data lines are vertically intersected to form multiple pixel regions, and the pixel region is a region that surrounded by two adjacent rows of scan lines and two adjacent columns of data lines; the multiple sub-pixels arranged as a matrix are respectively located in the multiple pixel regions, and each of the sub-pixels is connected to the scan line and the data line; wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed.

Preferably, different scanning line segments on each scanning line are used to individually input scanning signals, and different data line segments on each data line are used to individually input data signals.

Preferably, the multiple first breakpoints are located between two data lines, the multiple second breakpoints are located between two scanning lines; when the multiple scanning lines are inputted with the scanning signals, and the multiple data lines are inputted with the data signals, the sub-pixels arranged as a matrix form a region having a brightness gradient.

Preferably, the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

Preferably, the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

Preferably, each row of the sub-pixels in the multiple sub-pixels arranged as a matrix is connected to a same row of scan line, and each column of the sub-pixels is connected to a same column of data line.

The present invention also provides a large-size liquid crystal display, comprising: multiple sub-pixels arranged as a matrix, multiple rows of scanning lines, and multiple columns of data lines; the multiple rows of scan lines and the multiple columns of data lines are vertically intersected to form multiple pixel regions, and the pixel region is a region that surrounded by two adjacent rows of scan lines and two adjacent columns of data lines; the multiple sub-pixels arranged as a matrix are respectively located in the multiple pixel regions, and each of the sub-pixels is connected to the scan line and the data line; wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed; wherein different scanning line segments on each scanning line are used to individually input scanning signals, and different data line segments on each data line are used to individually input data signals; and wherein each row of the sub-pixels in the multiple sub-pixels arranged as a matrix is connected to a same row of scan line, and each column of the sub-pixels is connected to a same column of data line.

Preferably, the multiple first breakpoints are located between two data lines, the multiple second breakpoints are located between two scanning lines: when the multiple scanning lines are inputted with the scanning signals, and the multiple data lines are inputted with the data signals, the sub-pixels arranged as a matrix form a region having a brightness gradient.

Preferably, the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

Preferably, the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

The present invention also provides a large-size liquid crystal display, comprising: multiple sub-pixels arranged as a matrix, multiple rows of scanning lines, and multiple columns of data lines; the multiple rows of scan lines and the multiple columns of data lines are vertically intersected to form multiple pixel regions, and the pixel region is a region that surrounded by two adjacent rows of scan lines and two adjacent columns of data lines; the multiple sub-pixels arranged as a matrix are respectively located in the multiple pixel regions, and each of the sub-pixels is connected to the scan line and the data line; wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed; and the multiple first breakpoints are located between two data lines, the multiple second breakpoints are located between two scanning lines; when the multiple scanning lines are inputted with the scanning signals, and the multiple data lines are inputted with the data signals, the sub-pixels arranged as a matrix form a region having a brightness gradient.

Preferably, the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

Preferably, the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

Preferably, each row of the sub-pixels in the multiple sub-pixels arranged as a matrix is connected to a same row of scan line, and each column of the sub-pixels is connected to a same column of data line.

The implementation of the present invention has the following beneficial effects: the present invention provides a large-size liquid crystal display in which the location of the first breakpoints on the multiple scanning lines are random, and the location of the second breakpoints on the multiple data lines are random. Therefore, when the two scanning line segments on each scanning line are respectively inputted with scanning signals for driving, and when two data line segments on each data line are respectively inputted with data signals for driving, even the two scanning line segments on each scanning line have a driving difference, or two data line segment on each data line have a driving difference, since the first breakpoints and the second breakpoints are randomly distributed, the brightness of the light emitted by the multiple sub-pixels in a specific region can be neutralized, and a brightness gradient region is formed on the liquid crystal display to eliminate a poor display of the large-size liquid crystal display. The boundary of the four display regions 11, 12, 13, 14 in FIG. 1 will not generate a bad display.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a large-size liquid crystal display according to the conventional art.

FIG. 2 is a schematic diagram of a driving circuit of a large-size liquid crystal display according to the conventional art.

FIG. 3 is a schematic diagram of locations of breakpoints of scanning lines in FIG. 2 according to the conventional art.

FIG. 4 is a schematic diagram of locations of breakpoints of data lines in FIG. 2 according to the conventional art.

FIG. 5 is a schematic diagram of a driving circuit of a large-size liquid crystal display provided by the present invention.

FIG. 6 is a schematic diagram of locations of first breakpoints on scanning lines in FIG. 5 provided by the present invention.

FIG. 7 is a schematic diagram of locations of second breakpoints on data lines in FIG. 5 provided by the present invention.

### DETAILED DESCRIPTION OF PREFERRED EMBODIMENTS

The present invention provides a large-size liquid crystal display comprising multiple sub-pixels for emitting light arranged as a matrix, multiple rows of scanning lines, and multiple columns of data lines. In general, a liquid crystal display having a display screen larger than 50 inches can be referred to as a large-size liquid crystal display. The large-size liquid crystal display is a single-panel screen display device.

The multiple rows of scan lines and the multiple columns of data lines are vertically intersected to form multiple pixel regions, and the pixel region is a region that surrounded by two adjacent rows of scan lines and two adjacent columns of data lines. For example, a region surrounded by a first row of scanning line G5, a second row of scanning line G4, a first column of data line D-5 and a second column of data line D-4 in FIG. 5 is a pixel region.

The multiple sub-pixels arranged as a matrix are respectively located in the multiple pixel regions, and each of the sub-pixels is connected to the scan line and the data line.

Wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed.

As shown in FIG. 5, in one embodiment, the multiple rows of scanning lines include a first row of scan line G5 to an eleventh row of scanning line G-5, and the multiple columns of data lines include a first column of data line D-5 to an eleventh column of data lines D5. In FIG. 5, two scanning line segments G51 and G52 of the first row of scanning line G5 are respectively located on two sides of a sixth column of data line D0, and two scanning line segments of the second row of scanning line G4 are respectively located on two sides of the eighth column of data line D2. Two scanning line segments of the eleventh row of scanning line G-5 are respectively located on two sides of the fifth column of data line D-1, that is, the first breakpoint of the first row of scanning line G5 is located on the sixth column of data line D0, the first breakpoint on the second row of scanning line G4 is located on the eighth column of data line D2, and the first breakpoint on the eleventh row of scanning line G-5 is located on the fifth column of data line D-1.

Similarly, as shown in FIG. 5, two data line segments D51 and D52 on the eleventh column of data line D5 are respectively located on two sides of the tenth row of scanning line G-4, that is, the second break point on the eleventh column of data line D5 is located at the tenth row of scanning line G-4, and the second breakpoint on the tenth column of data line D4 is on the sixth row of scanning line G0.

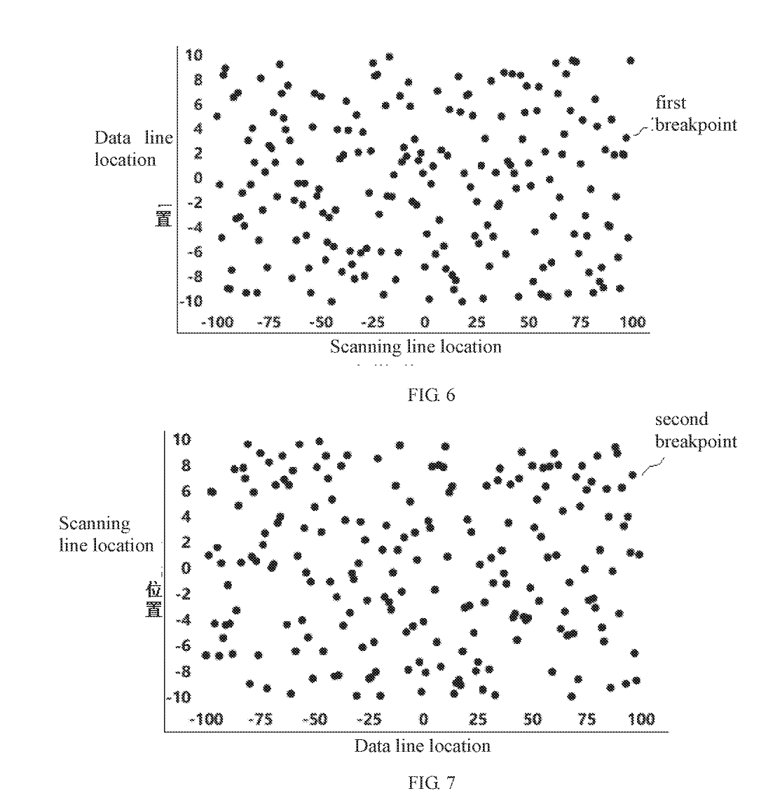

Referring to FIG. 6, the multiple first breakpoints corresponding to the multiple rows of scan lines are randomly distributed. As shown in FIG. 7, the multiple second breakpoints corresponding to the multiple columns of data lines are also randomly distributed.

Here, the horizontal and vertical coordinates of FIG. 6 indicate the location of the scanning lines (that is, the row number of the scanning lines) and the location of the data lines (that is, the column number of the data lines). The horizontal and vertical coordinates of FIG. 7 indicate the location of the data lines (that is, the column number of the data line) and the location of the scanning line (that is, the row number of the scanning line).

Furthermore, different scanning line segments on each scanning line are used to individually input scanning signals, and different data line segments on each data line are used to individually input data signals.

Furthermore, the multiple first breakpoints are located between two data lines, the multiple second breakpoints are located between two scanning lines. When the multiple scanning lines are inputted with the scanning signals, and the multiple data lines are inputted with the data signals, the sub-pixels arranged as a matrix form a region having a brightness gradient.

Furthermore, the multiple first breakpoints are located between two data lines which are not adjacent, and the multiple second breakpoints are located between two scanning lines which are not adjacent. Wherein, between two data lines which are not adjacent, multiple data lines are provided, and between two scanning lines which are not adjacent, multiple scanning lines are provided.

Furthermore, the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

For example, referring to FIG. 6, the column number of the most middle column of data line is 0, the row number of the most middle row of scanning line is 0, and the first breakpoint is located between the data lines having column numbers 10 and −10. Referring to FIG. 7, the column number of the most middle column of data line is 0, the row number of the most middle row of scanning line is 0, and the second breakpoint is between scanning lines having row numbers 10 and −10.

Furthermore, each row of the sub-pixels in the multiple sub-pixels arranged as a matrix is connected to a same row of scan line, and each column of the sub-pixels is connected to a same column of data line.

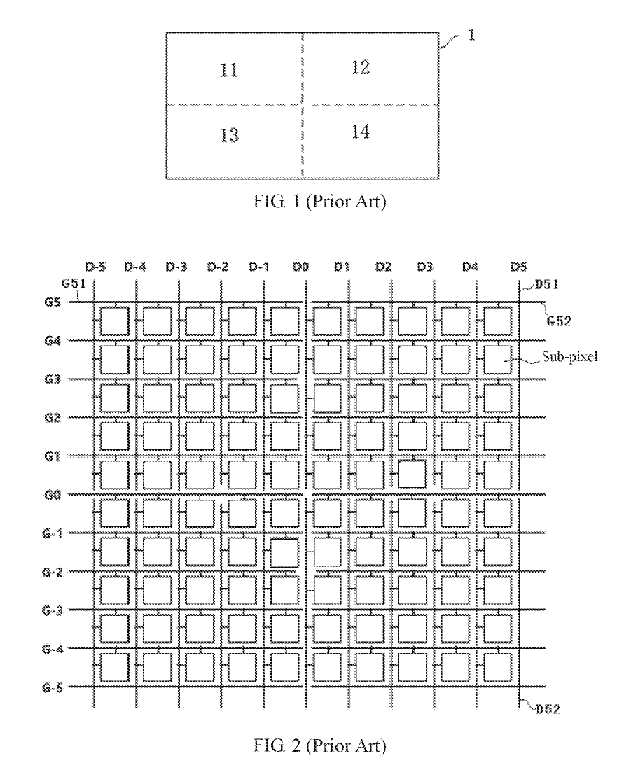

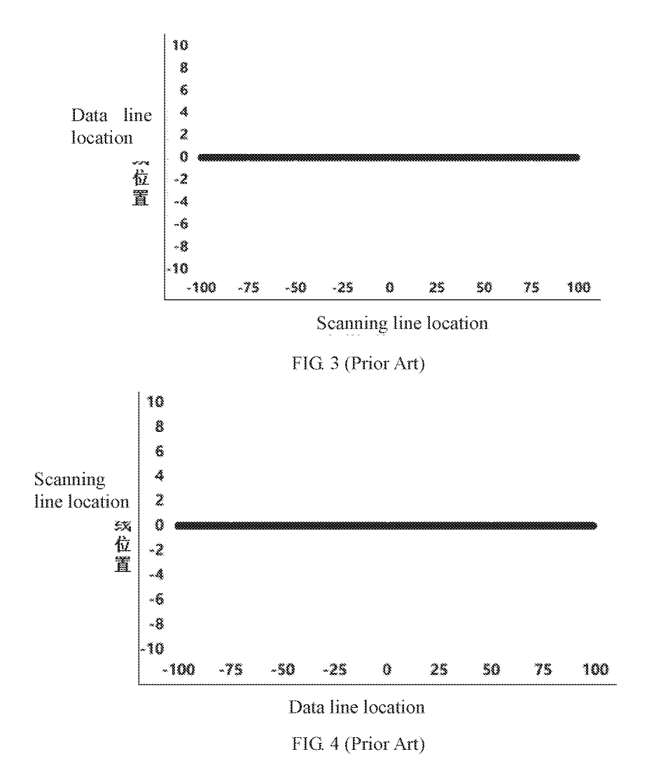

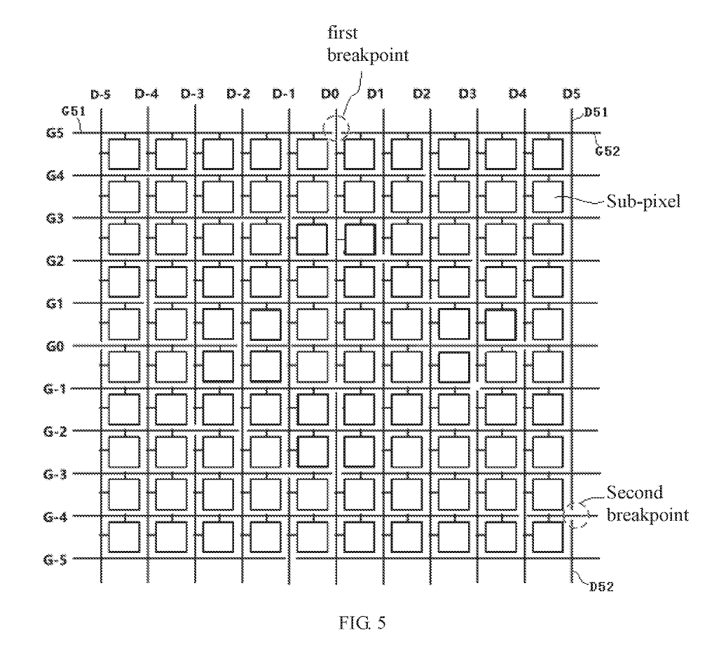

In summary, the present invention provides a large-size liquid crystal display in which the location of the first breakpoints on the multiple scanning lines are random, and the location of the second breakpoints on the multiple data lines are random. Therefore, when the two scanning line segments on each scanning line are respectively inputted with scanning signals for driving, and when two data line segments on each data line are respectively inputted with data signals for driving, even the two scanning line segments on each scanning line have a driving difference, or two data line segment on each data line have a driving difference, since the first breakpoints and the second breakpoints are randomly distributed, the brightness of the light emitted by the multiple sub-pixels in a specific region can be neutralized, and a brightness gradient region is formed on the liquid crystal display to eliminate a poor display of the large-size liquid crystal display. The boundary of the four display regions 11, 12, 13, 14 in FIG. 1 will not generate a bad display.

The above is a further detailed description of the present invention in connection with the specific preferred embodiments, and the specific embodiments of the present invention are not limited to the description. For those skilled in the art to which the present invention pertains, a number of simple derivations or substitutions may be made without departing from the inventive concept, and should be considered as the protection scope of the present invention.

What is claimed is:

1. A large-size liquid crystal display, comprising:
multiple sub-pixels arranged as a matrix, multiple rows of scanning lines, and multiple columns of data lines;
the multiple rows of scan lines and the multiple columns of data lines are vertically intersected to form multiple pixel regions, and the pixel region is a region that surrounded by two adjacent rows of scan lines and two adjacent columns of data lines;
the multiple sub-pixels arranged as a matrix are respectively located in the multiple pixel regions, and each of the sub-pixels is connected to the scan line and the data line;
wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed.

2. The large-size liquid crystal display according to claim 1, wherein different scanning line segments on each scanning line are used to individually input scanning signals, and different data line segments on each data line are used to individually input data signals.

3. The large-size liquid crystal display according to claim 2, wherein the multiple first breakpoints are located between two data lines, the multiple second breakpoints are located between two scanning lines; when the multiple scanning lines are inputted with the scanning signals, and the multiple data lines are inputted with the data signals, the sub-pixels arranged as a matrix form a region having a brightness gradient.

4. The large-size liquid crystal display according to claim 3, wherein the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

5. The large-size liquid crystal display according to claim 4, wherein the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

6. The large-size liquid crystal display according to claim 1, wherein each row of the sub-pixels in the multiple sub-pixels arranged as a matrix is connected to a same row of scan line, and each column of the sub-pixels is connected to a same column of data line.

7. A large-size liquid crystal display, comprising:
multiple sub-pixels arranged as a matrix, multiple rows of scanning lines, and multiple columns of data lines;
the multiple rows of scan lines and the multiple columns of data lines are vertically intersected to form multiple pixel regions, and the pixel region is a region that surrounded by two adjacent rows of scan lines and two adjacent columns of data lines;
the multiple sub-pixels arranged as a matrix are respectively located in the multiple pixel regions, and each of the sub-pixels is connected to the scan line and the data line;
wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed;
wherein different scanning line segments on each scanning line are used to individually input scanning signals, and different data line segments on each data line are used to individually input data signals; and
wherein each row of the sub-pixels in the multiple sub-pixels arranged as a matrix is connected to a same row of scan line, and each column of the sub-pixels is connected to a same column of data line.

8. The large-size liquid crystal display according to claim 7, wherein the multiple first breakpoints are located between two data lines, the multiple second breakpoints are located between two scanning lines; when the multiple scanning lines are inputted with the scanning signals, and the multiple data lines are inputted with the data signals, the sub-pixels arranged as a matrix form a region having a brightness gradient.

9. The large-size liquid crystal display according to claim 8, wherein the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

10. The large-size liquid crystal display according to claim 9, wherein the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

11. A large-size liquid crystal display, comprising:
multiple sub-pixels arranged as a matrix, multiple rows of scanning lines, and multiple columns of data lines;
the multiple rows of scan lines and the multiple columns of data lines are vertically intersected to form multiple pixel regions, and the pixel region is a region that surrounded by two adjacent rows of scan lines and two adjacent columns of data lines;
the multiple sub-pixels arranged as a matrix are respectively located in the multiple pixel regions, and each of the sub-pixels is connected to the scan line and the data line;
wherein each row of the scanning lines includes two scanning line segments, and each column of data lines also includes two data line segments, and a space between the two scanning line segments on each scanning line is set as a first breakpoint, a space between the two data line segments on each data line is set as a second breakpoint, and multiple first breakpoints corresponding to the multiple rows of scanning lines are randomly distributed, and multiple second breakpoints corresponding to the multiple columns of data lines are randomly distributed; and
the multiple first breakpoints are located between two data lines, the multiple second breakpoints are located between two scanning lines; when the multiple scanning lines are inputted with the scanning signals, and the multiple data lines are inputted with the data signals, the sub-pixels arranged as a matrix form a region having a brightness gradient.

12. The large-size liquid crystal display according to claim 11, wherein the multiple first breakpoints are located between two data lines which are not adjacent, and the multiple second breakpoints are located between two scanning lines which are not adjacent; wherein, between two data lines which are not adjacent, multiple data lines are provided, and between two scanning lines which are not adjacent, multiple scanning lines are provided.

13. The large-size liquid crystal display according to claim 12, wherein the two data lines which are not adjacent are symmetrically distributed on two sides of a central axis of the multiple columns of data lines, and the two scanning lines which are not adjacent are symmetrically distributed on two sides of a central axis of the multiple rows of scanning lines.

14. The large-size liquid crystal display according to claim 11, wherein each row of the sub-pixels in the multiple sub-pixels arranged as a matrix is connected to a same row of scan line, and each column of the sub-pixels is connected to a same column of data line.
